(19) United States
(12) Patent Application Publication
(10) Pub. No.: US 2015/0146999 A1
(43) Pub. Date: May 28, 2015

(54) METHOD AND APPARATUS TO CORRECT DISTORTIONS IN MAGNETIC RESONANCE DIFFUSION IMAGES

(71) Applicant: Siemens Aktiengesellschaft, Muenchen (DE)

(72) Inventors: Thorsten Feiweier, Poxdorf (DE); Stefan Huwer, Erlangen (DE)

(73) Assignee: Siemens Aktiengesellschaft, Muenchen (DE)

(21) Appl. No.: 14/554,330

(22) Filed: Nov. 26, 2014

(30) Foreign Application Priority Data
Nov. 28, 2013 (DE) 102013224406.1

(51) Int. Cl. G06T 11/00; G06T 5/00

(52) U.S. Cl. CPC G06T 11/008; G06T 5/002; G06T 2207/10088; G06T 2207/20182
USPC 382/275

(57) ABSTRACT

In a method and apparatus to correct distortions in magnetic resonance diffusion images, a distortion model is provided to a computer, at least one reference image is acquired, multiple diffusion images are acquired and after the acquisition of one diffusion image of the multiple diffusion images the following steps are executed in the computer. The diffusion image is brought into registration with the at least one reference image, the distortion model is adapted using the result of the registration, and distortions of the diffusion image are corrected using the distortion model.

### BACKGROUND OF THE INVENTION

1. Field of the Invention

The invention concerns a method to correct distortions in magnetic resonance diffusion images as well as a magnetic resonance apparatus and a non-transitory, computer-readable data storage medium encoded with programming instructions to implement such a method.

2. Description of the Prior Art

In magnetic resonance diffusion imaging, multiple diffusion images with different diffusion directions and/or diffusion weightings, which are typically characterized by a b-value, are normally acquired. The diffusion images can then be combined in order to calculate parameter maps, for example an ADC map that includes apparent diffusion coefficients (ADCs), or an FA map that includes fractional anisotropy coefficients.

In diffusion images, image distortions can be present that are caused by eddy current fields generated by the diffusion gradients. The appearance of the image distortions typically depends both on the amplitude of the gradient and on its direction. Particularly in diffusion-weighted echoplanar imaging, high gradient amplitudes (diffusion gradients) are used in combination with a high sensitivity to static and dynamic field interference. Distortions due to eddy currents are thus regularly present in diffusion-weighted echoplanar imaging. If the acquired, individual diffusion images are combined with one another without a correction of the image distortions—in particular to calculate a parameter map—the different distortions for each diffusion image possibly lead to incorrect associations of pixel information, and therefore to errors (or at least a reduced precision) of the calculated parameter maps.

From DE 10 2009 003 889 B3, a method is known that, on the basis of adjustment measurements, corrects image distortions that arise given acquisition of diffusion-weighted magnetic resonance images.

From DE 10 2010 001 577 B4, a method is known that, on the basis of system-specific information—corrects image distortions that arise given acquisition of diffusion-weighted magnetic resonance images.

### SUMMARY OF THE INVENTION

An object of the invention is to enable a rapid and robust correction of distortions in diffusion images acquired by means of a magnetic resonance apparatus.

The method according to the invention for correction of distortions in diffusion images of an examination subject that are acquired by a magnetic resonance apparatus, has the following steps:
provide a distortion model to a computer,
acquire at least one reference image,
acquire multiple diffusion images, and after the acquisition of one diffusion image of the multiple diffusion images the following steps are executed:
bring the diffusion image into registration with the at least one reference image in the computer,
adapt the distortion model i the computer using the result of the registration,
correct distortions of the diffusion image using the distortion model, and
make the corrected diffusion image available in electronic form such as a data file, at an output of the computer.

The acquisition of the at least one reference image and/or of the multiple diffusion images can be implemented by the operation of the magnetic resonance apparatus. Alternatively or additionally, the acquisition of the at least one reference image and/or of the multiple diffusion images can be implemented by loading at least one previously acquired reference image and/or of multiple previously acquired diffusion images into the computer, for example from a database. The examination subject can be a phantom, training personnel, a test subject or a patient, for example.

During a measurement of the examination subject, a number of diffusion images are acquired, typically with different diffusion directions and/or diffusion-weightings (b-values). The multiple diffusion images that are used for adaptation of the distortion model do not necessarily need to all be diffusion images that are acquired from the examination subject during a measurement. In particular, diffusion images with a lower image quality (for example with a low signal-to-noise ratio due to a high diffusion weighting) are possibly unsuitable for an adaptation of the distortion model. Computing time and computing costs can thus be saved, and a high validity and/or robustness of the distortion model can be ensured.

The at least one reference image can be a diffusion image, and the at least one reference image advantageously has only very slight or no distortions. For this purpose, the at least one reference image preferably has a low diffusion weighting, for example with a b-value of less than 200 s/mm², preferably of less than 100 s/mm², advantageously of less than 50 s/mm², most advantageously of 0 s/mm². The at least one reference image can either be acquired separately (for example as an adjustment measurement) or can already belong to the clinical image data. If additional diffusion images with a lower diffusion weighting and/or undistorted images should be acquired in the course of the measurement of the examination subject, these can thus be used as a new reference image for the registration of the following diffusion images. This procedure offers the advantage that possible movements of the patient can be taken into account in the registration process. The at least one reference image can also include a template image derived from the distortion model, which template image has a contrast similar to that of the currently acquired diffusion image. Possible contrast diffusions between the diffusion images and the at least one reference image can thus be avoided, and the reference of the diffusion image with the at least one reference image can be improved. Insofar as movements of the examination subject are detected and/or quantified, the template image can be adapted corresponding to a rigid body model in order to improve the registration of the diffusion image.

The adaptation of the distortion model can take place slice-specifically for individual slices of the diffusion image, and the correction of the distortions of the diffusion image can be implemented per slice by means of the slice-specific distortion model. A slice-specific distortion model which is specific to a defined slice of the diffusion image can thereby be used for correction of the distortions of a slice of the diffusion image that is adjacent to the defined slice. This is advantageous when the adjacent slice has a low image content. The adaptation of the distortion model can also take place in three dimensions, in particular using a three-dimensional distortion model. A registration of the entire slice stack of the diffusion image—i.e. of the complete image volume of the diffusion image—with the slice stack of the reference image preferably takes place simultaneously.

The provision of the distortion model can include a selection of a physical model that is suitable for the distortions that are to be expected. The distortion model is based on underlying assumptions, for example of the linearity and/or the superposition of distortion fields, in particular of eddy current fields. The distortion model can take into account different types of distortions. The provision of the distortion model can include an initialization of the model with initial parameters. The first-time adaptation of the distortion model using the result of the registration can also include a design of the provided distortion model with initial parameters which are obtained from the result of the registration.

At least the following two steps are preferably executed iteratively, after the acquisition of one diffusion image of the multiple diffusion images: registration of the diffusion image with the at least one reference image; adaptation of the distortion model using the result of the registration. The correction of the distortions of the diffusion image using the distortion model can also take place iteratively, respectively after the acquisition of one diffusion image of the multiple diffusion images. The correction of the distortions can also take place at least partially (in particular entirely) separately from the adaptation of the distortion model. For example, during the running measurement the diffusion images can be used only for the design and/or the adaptation of the distortion model. The diffusion images can thereby initially be stored uncorrected in a database. After the end of the measurement and/or production (in particular finalization) of the adaptation of the distortion model, the diffusion images are then advantageously subjected to the correction of the distortions in a separate pass. This pure correction of the distortions can thereby be implemented with less computing time than the adaptation of the distortion model. Furthermore, it can therefore be ensured that the distortions of all diffusion images are corrected with a completely adapted (and thus particularly robust) distortion model. The step of the correction of the distortions of the diffusion image using the distortion model can accordingly be executed separately from the other steps.

Conventional procedures for correction of distortions of diffusion images provide that dedicated adjustment measurements with defined parameters (for example established diffusion gradient amplitudes along physical gradient axes) are implemented before the acquisition of the diffusion images, wherein the distortions are corrected using the adjustment images acquired in the adjustment measurements. In contrast to this, within the scope of the method according to the invention adjustment measurements are advantageously foregone. Measurement time can thus be saved. Rather, the diffusion images themselves can be viewed as adjustment images. The diffusion images are typically better suited to the adaptation of the distortion model than separately acquired adjustment images, since the distortions of the adjustment images are too small (for example if small diffusion gradients are used) to be able to reliably extrapolate the distortions of the diffusion images.

Additional conventional procedures for correction of distortions of diffusion images provide a correction of the distortions of a diffusion image directly using the registration of this diffusion image with a reference image. In contrast to this, within the scope of the method according to the invention a distortion model is used to correct the distortions of the diffusion images, wherein the distortion model is adapted iteratively using the registration of multiple diffusion images. The proposed method therefore offers the advantage that distortions of diffusion images with a low image quality (for example a low signal-to-noise ratio, in particular due to a high diffusion weighting) can be reliably corrected. For this purpose, the adaptation of the distortion model can take place using different diffusion images with a higher image quality. During a measurement of the examination subject with different diffusion weightings and/or diffusion directions, a design and/or an adaptation of the distortion model can also already take place on the basis of the diffusion images themselves. The computationally costly adaptation of the distortion model can thus already take place during a running measurement to acquire the diffusion images, whereby measurement time and/or computing time can be saved. The corrected diffusion images and/or the parameter maps created on the basis of the corrected diffusion images can thus be provided more quickly after the end of the measurement.

In an embodiment, a determination of a quality measure takes place on the basis of the diffusion image after the acquisition of said diffusion image, wherein the adaptation of the distortion model takes place using the quality measure. The quality measure can represent a measure of how well the diffusion image (with regard to which the quality measure has been calculated) is suited to the adaptation of the distortion model. The quality measure can thus describe whether the diffusion image is suitable for an improvement of the distortion model. A higher quality measure can thus lead to the situation that the diffusion image—in particular the result of the registration of the diffusion image with the at least one reference image—enters with a weaker weighting into the adaptation of the distortion model. The determination and the consideration of the quality measure thus lead to an improvement of the robustness of the distortion model.

In another embodiment, the determination of the quality measure includes a use of a cost function used during the registration of the diffusion image with the at least one reference image. The quality measure can thus be derived directly from the cost function used during the registration of the diffusion image with the at least one reference image. This approach is based on the consideration that diffusion images which could be registered precisely with the at least one reference image are typically especially suitable for an improvement of the distortion model. For example, depending on the registration algorithm that is used the distortion model is a correlation coefficient, a cross-correlation coefficient and/or a normalized mutual information coefficient (NMI coefficient). The cited cost functions represent typical and advantageous cost functions for the registration. Naturally, the use of other cost functions is conceivable. Alternatively or additionally, the quality measure can be described on the basis of the change of the cost function, in particular given a variation of the at least one distortion correction parameter described in the following. The quality measure can also be determined on the basis of an analysis of the form of a local minimum of the registration of the diffusion image. The determination of the quality measure on the basis of the cost function used during the registration of the diffusion image with the at least one reference image offers an effective and significant possibility to determine the quality measure.

In another embodiment, the determination of the quality measure includes a use of a measured value which represents a measure of the image quality of the diffusion image. This approach is based on the consideration that diffusion images with a higher image quality are typically particularly suitable for an improvement of the distortion model. For example, the measured value can include the (in particular averaged) signal-to-noise ratio and/or contrast-to-noise ratio of the diffusion image. The measured value can also be derived from the b-value which was used to acquire the diffusion image, since a higher b-value typically leads to a lower image quality of the diffusion image. Naturally, other measures for the image quality of the diffusion image can be used. The determination of the quality measure on the basis of the measured value which represents a measure of the image quality of the diffusion image offers an additional effective and significant possibility to determine the quality measure. The quality measure can also be determined simultaneously and/or in combination on the basis of the cost function and the measured value.

In another embodiment, at least one distortion correction parameter is determined using the result of the registration of the diffusion image, wherein the adaptation of the distortion model takes place using the at least one distortion correction parameter. The at least one distortion correction parameter is typically designed depending on the distortion model that is used. The at least one distortion correction parameter can thus represent an estimate value for the distortion model and/or for parameters of the distortion model. Multiple distortion correction parameters can also be determined using the registration of the diffusion image, and for adaptation of the distortion model, for example if higher-order distortions should be taken into account. It is advantageous that the correction of the distortions of the diffusion image does not take place directly using the at least one distortion correction parameter, since the at least one distortion correction parameter is typically plagued with noise. It is therefore advantageous to correct the distortions of the diffusion image using parameters estimated from the distortion model which was adapted using the at least one distortion correction parameter, since the distortion model smooths noise and thus in particular improves the robustness of the correction given diffusion images with low image quality.

In another embodiment, in the adaptation of the distortion model, a weighting of the at least one distortion correction parameter takes place relative to an additional distortion correction parameter which is determined using the result of the registration of an additional diffusion image. The at least one distortion correction parameter advantageously enters with weighting into the adaptation of the distortion model. Distortion correction parameters that are particularly suitable for an improvement of the distortion model can then enter with stronger weighting into the adaptation of the distortion model. This can improve the validity and robustness of the distortion model.

In another embodiment, the weighting of the consideration of the at least one distortion correction parameter is implemented using at least one error covariance which is determined on the basis of the diffusion image. The determination of the at least one error covariance advantageously includes a use of a calibration measurement that has previously taken place. The calibration measurement can thereby include measurement series with typical diffusion gradients. The error covariance can thus be calculated specific to the respective magnetic resonance apparatus with which the diffusion image was acquired. The weighting of the consideration of the at least one distortion correction parameter can thus likewise take place specific to the system.

In another embodiment, at least one distortion correction parameter is determined using the result of the registration of the diffusion image, wherein the adaptation of the distortion model takes place using the at least one distortion correction parameter, wherein given adaptation of the distortion model a weighting of the at least one distortion correction parameter takes place relative to an additional distortion correction parameter which is determined using the result of the registration of an additional diffusion image. A distortion correction parameter which is determined using the result of a registration of a diffusion image can thus enter with a higher weighting into the adaptation of the distortion model if a higher degree of quality is present. The degree of quality represents a particularly simple and effective possibility for weighting the at least one distortion correction parameter.

In an embodiment, the distortion model includes at least one property from the following group: modeling of a translation of the diffusion image, modeling of a shearing of the diffusion image, modeling of a scaling of the diffusion image, modeling of a nonlinear distortion of the diffusion image. Naturally, additional affine and/or geometric mappings for the distortion model are also conceivable. However, the cited mappings represent typical and advantageous mappings for the distortion model. If at least one distortion correction parameter for adaptation of the distortion model is used, the at least one distortion correction parameter can include the at least one property. The translation, shearing, scaling and/or nonlinear distortion can thereby respectively be modeled separately for three spatial directions (in particular the gradient axes) and/or separately for the readout direction, phase direction and/or slice direction of the diffusion images. This procedure is based on the consideration that distortion fields (in particular eddy current fields) superimpose independently of one another along different orthogonal axes.

In an embodiment, the registration of the diffusion image includes a use of a start value for the registration, wherein the start value is determined using the distortion model. In this way, the registration of the diffusion image with the at least one diffusion image can be accelerated and save calculation time. The start value is advantageously determined using the current distortion model, which was adapted in the previous iteration using the previous diffusion image. In particular, the start value is thereby determined using the current parameter of the distortion model.

One embodiment provides that the adaptation of the distortion model includes a reduction of the dimension of the distortion model. The distortion model can hereby be calculated so as to save storage space and/or calculation time. In particular given extensive measurements with many diffusion images with different b-values (for example the DSI or HARDI method), it is advantageous to keep only the respective current measurement for the adaptation of the distortion model in computational memory.

In an embodiment, the adaptation of the distortion model includes a calculation of a value of a goodness of fit which represents a measure of the deviation of the distortion model from distortions of the diffusion image. The goodness of fit thus typically describes a deviation of the distortion model from actual observed values. A high goodness of fit therefore typically represents an indication that a valid distortion model is present. The goodness of fit thus typically describes how well the present distortion model describes the actual measured distortions of the diffusion image.

In another embodiment, an adaptation of the distortion model is finalized depending on the calculated value of the goodness of fit. The finalization of the adaptation of the distortion model can mean that the distortion model is no longer adapted further in the following iterations. If a high goodness of fit is accordingly present (for example above a first threshold), an additional adaptation of the distortion model can thus be omitted. Computing resources can thus be spared. The goodness of fit can thereby be calculated using parameters which are specific to the magnetic resonance apparatus which is used to acquire the diffusion images.

In another embodiment, the correction of the distortions of the diffusion image is implemented depending on the calculated value of the goodness of fit. In particular, if the goodness of fit is below a second threshold, a correction of the diffusion image present in the respective iteration is initially foregone. The distortions of these initially uncorrected diffusion images can then be corrected with the present distortion model with the higher degree of closeness of fit in following iterations as soon as the goodness of fit of the distortion model has exceeded the second threshold. It can thus be ensured that only distortion models which have a certain minimum quality and/or validity are used to correct the distortions of the diffusion images.

In another embodiment, the acquisition of the multiple diffusion images takes place with a different diffusion weighting, wherein the adaptation of the distortion model according to the registration of a first diffusion image with a first diffusion weighting takes place chronologically before the adaptation of the distortion model according to the registration of a second diffusion image with a second diffusion weighting, wherein the first diffusion weighting is smaller than the second diffusion weighting. In particular, the b-value of the first diffusion weighting is smaller than the b-value of the second diffusion weighting. In particular, the b-value of the first diffusion weighting is smaller than the b-value of the second diffusion weighting. It is advantageous that, during a measurement of the examination subject, diffusion images with a weaker diffusion weighting (in particular with smaller b-values) are initially acquired since these diffusion images typically have a higher image quality and smaller distortions, and thus are particularly suitable for an adaptation of the distortion model. A valid distortion model—in particular with a sufficiently high goodness of fit—can therefore be present particularly quickly, in particular already after a few iterations. This distortion model can then initially be particularly suitable for correcting the distortions in the diffusion images with the low diffusion weighting. In the further course of the measurement, diffusion images with higher diffusion weightings (in particular larger b-values) can then be acquired which then have larger distortions and can be used to refine the distortion model. For these diffusion images, an advanced distortion model (meaning a distortion model that is adapted in multiple iteration steps) is then also already present which can effectively correct the distortions in the diffusion images with the larger diffusion weighting. With the inventive procedure, computing time and storage space can be saved in the adaptation of the distortion model. Furthermore, a distortion model adapted to the respective strength of the distortion of the diffusion image can be used to correct the distortions.

In another embodiment, the acquisition of the chronologically first diffusion images of the multiple diffusion images includes a use of different diffusion directions. A valid distortion model—in particular with a sufficiently high closeness of fit—can thus likewise be present particularly quickly, in particular already after a few iterations.

The magnetic resonance apparatus according to the invention has an image data acquisition unit and a computer that are designed to execute the method according to the invention for the correction of distortions in diffusion images of an examination subject that are acquired by the magnetic resonance apparatus. The computer has a provisioning unit which is designed to provide a distortion model. The image data acquisition unit is designed to acquire at least one reference image and to acquire multiple diffusion images. The computer has a registration unit which is designed to register the diffusion image with the at least one reference image. The computer has an adaptation unit which is designed to adapt the distortion model using the result of the registration. The computer has a correction unit which is designed to correct distortions of the diffusion image using the distortion model. The registration of the diffusion image, the adaptation of the distortion model and the correction of the distortions thereby take place after the acquisition of one diffusion image of the multiple diffusion images. Embodiments of the magnetic resonance apparatus according to the invention are designed analogous to the embodiments of the method according to the invention. For this purpose, computer programs and additional software can be stored in a memory unit of the magnetic resonance apparatus, by means of which computer programs and additional software a processor of the magnetic resonance apparatus automatically controls and/or executes a method workflow of a method according to the invention. The magnetic resonance apparatus thus enables a fast and robust correction of distortions of diffusion images which have been acquired by the magnetic resonance apparatus.

The present invention also encompasses a non-transitory, computer-readable data storage medium encoded with programming instructions that, when the storage medium is loaded into a control and processing computer system of a magnetic resonance apparatus, cause the magnetic resonance apparatus to be operated in accordance with the method as described above.

The computer must have component such as working memory, a graphics card or a logic unit so that the method steps can be executed efficiently. Examples of electronically readable data media are a DVD, a magnetic tape or a USB stick on which the electronically readable control information is stored. All embodiments according to the invention of the method described in the preceding can be implemented when this control information (software) is read from the data medium and stored in a controller and/or computer of a magnetic resonance apparatus.

The advantages of the method that are described above apply as well to the magnetic resonance apparatus in accordance with the invention, and the non-transitory, computer-readable data storage medium according to the invention.

### BRIEF DESCRIPTION OF THE DRAWINGS

FIG. 1 is a block diagram of a magnetic resonance apparatus according to the invention for execution of the method according to the invention.

FIG. 2 is a flowchart of an embodiment of a method according to the invention.

FIG. 3 is a more detailed flowchart of an embodiment of a method according to the invention.

### DESCRIPTION OF THE PREFERRED EMBODIMENTS

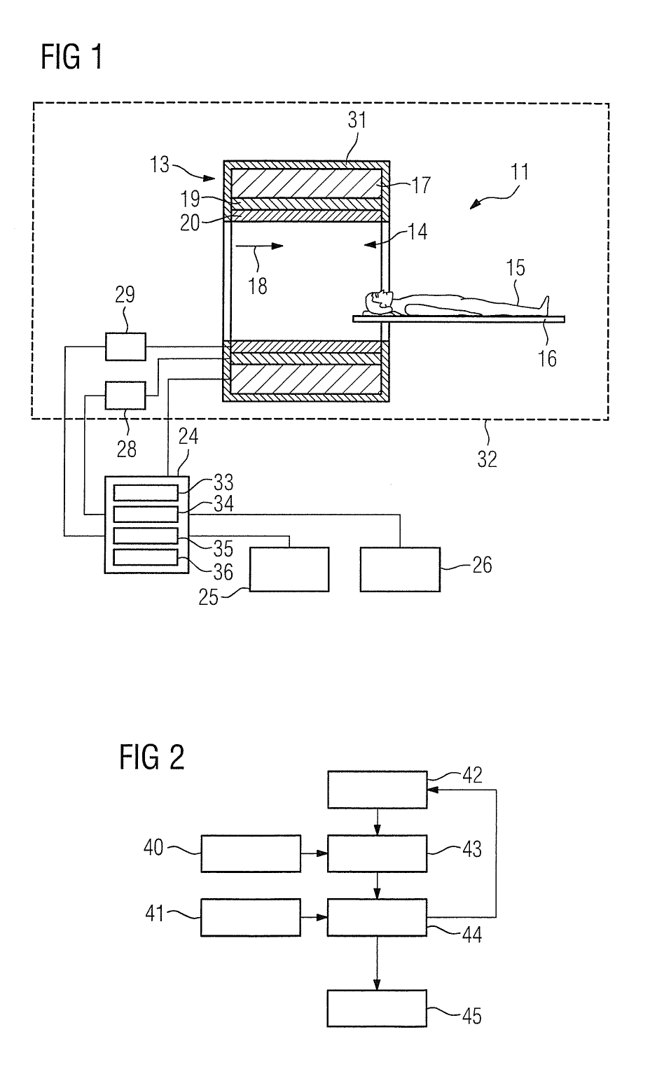

FIG. 1 shows a magnetic resonance apparatus 11 according to the invention for execution of a method according to the invention. The magnetic resonance apparatus 11 has a magnet unit 13 with a basic magnet 17 to generate a strong and in particular constant basic magnetic field 18. In addition to this, the magnetic resonance apparatus 11 has a patient accommodation region 14 (fashioned to be cylindrical in the shown case) to accommodate an examined person 15 (in particular a patient 15), wherein the patient accommodation region 14 is cylindrically enclosed by the magnet unit 13 in a circumferential direction. The patient 15 can be slid into the patient accommodation region 14 by means of a patient bearing device 16 of the magnetic resonance apparatus 11. For this, the patient bearing device 16 has a recumbent table that is arranged so as to be movable within the magnetic resonance apparatus 11. The magnet unit 13 is externally shielded by a housing casing 31 of the magnetic resonance apparatus 11.

The magnet unit 13 furthermore has a gradient coil unit 19 to generate magnetic field gradients that are used for a spatial coding during an imaging. The gradient coil unit 19 is controlled by a gradient control unit 28. Furthermore, the magnet unit 13 has: a radio-frequency antenna unit 20 which, in the shown case, is designed as a body coil permanently integrated into the magnetic resonance apparatus 11; and a radio-frequency antenna control unit 29 to excite a polarization that arises in the basic magnetic field 18 generated by the basic magnet 17. The radio-frequency antenna unit 20 is controlled by the radio-frequency antenna control unit 29 and radiates radio-frequency magnetic resonance sequences into an examination space that is essentially formed by the patient accommodation region 14. The radio-frequency antenna unit 20 is furthermore designed to receive magnetic resonance signals, in particular from the patient 15.

The magnetic resonance apparatus 11 has a computer 24 to control the basic magnet 17, the gradient control unit 28 and the radio-frequency antenna control unit 29. The computer 24 centrally controls the magnetic resonance apparatus 11, for example the implementation of a predetermined imaging gradient echo sequence. Control information (for example imaging parameters) as well as reconstructed magnetic resonance images can be displayed to an operator at a display unit 25—for example on at least one monitor—of the magnetic resonance apparatus 11. In addition to this, the magnetic resonance apparatus 11 has an input unit 26 by means of which information and/or parameters can be input by an operator during a measurement process and/or a display process of image data. The computer 24 can directly pass control commands to the gradient control unit 28 and the radio-frequency antenna control unit 29. Furthermore, the computer comprises a provisioning unit 33, a registration unit 34, an adaptation unit 35 and a correction unit 36. The magnet unit 13, the gradient control unit 28 and the radio-frequency antenna control unit 29 are comprised by an image data acquisition unit 32 of the magnetic resonance apparatus 11. With the image data acquisition unit 32 and the computer 24, the magnetic resonance apparatus 11 is designed to execute a method according to the invention.

The shown magnetic resonance apparatus 11 can naturally have additional components that magnetic resonance apparatuses conventionally have. The basic operation of a magnetic resonance apparatus is known to those skilled in the art, such that a more detailed description of the additional components is not necessary herein.

FIG. 2 shows a flowchart of an embodiment of a method according to the invention. An acquisition of at least one reference image takes place in a method step 40 by the image data acquisition unit 32 of the magnetic resonance apparatus 11. Alternatively or additionally, the at least one reference image can also be loaded from a database. In a further method step 41, a provisioning of a distortion model takes place by means of the provisioning unit 33 of the computer 24. In a further method step 42, an acquisition of multiple diffusion images takes place by means of the image data acquisition unit 32 of the magnetic resonance apparatus 11. Alternatively or additionally, the diffusion images can also be loaded from a database. After the acquisition of one diffusion image of the multiple diffusion images, in a further method step 43 a registration of the diffusion image with the at least one reference image takes place by means of the registration unit 34 of the computer 24, and in a further method step 44 an adaptation of the distortion model using the result of the registration takes place by means of the adaptation unit 35 of the computer 24. After the conclusion of the adaptation of the distortion model, in a further method step 45 a correction of distortions of the diffusion images using the distortion model takes place by means of the correction unit 36 of the computer 24. Alternatively, a correction of the distortions of the diffusion image can also take place directly after the acquisition of the diffusion image of the multiple diffusion images in the further step 42 and the adaptation of the distortion model using the result of the registration of the diffusion image.

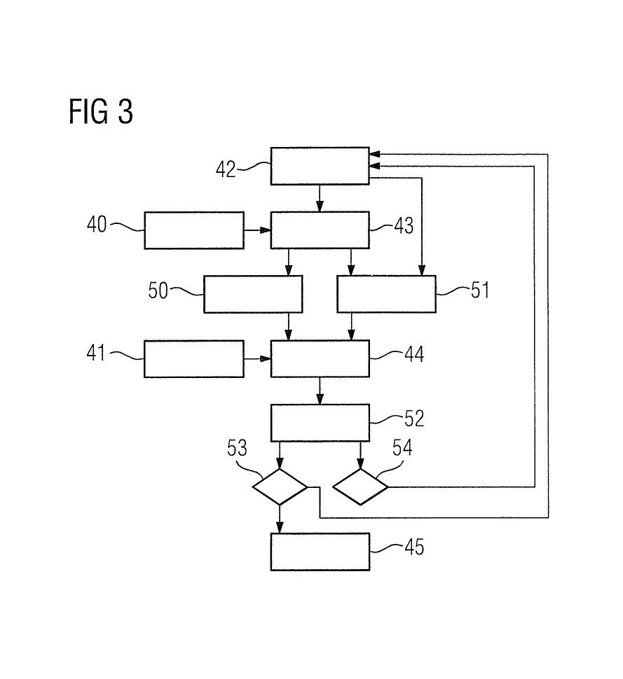

FIG. 3 shows a more detailed workflow diagram of an embodiment of a method according to the invention. The method steps 40, 41, 42, 43, 44 and 45 hereby correspond to the corresponding method steps of FIG. 2. In the following, vectors and matrices are identified with letters and/or symbols printed in bold face. Scalar values are not printed in bold face.

The distortion model provided in the further method step 41 by means of the provisioning unit 33 is thereby based on the assumption of a linearity principle. This means that distortion fields ΔB₀(r, g^{j})—in particular eddy current fields—scale linearly with the amplitude gi of the diffusion gradients that are used, which is described by the gradient vector g=(g^{x}g^{y}g^{z})^{T}:

ΔB₀(r,g^{j})=g^{j}/g^{j}_{ref}*ΔB₀(r,g^{j}_{ref}); with jε{x,y,z}

Furthermore, the distortion model is based on the assumption of a superposition principle. This means that distortion fields (in particular eddy current fields) generated by different gradient axes (for example the x-, y- and z-axis) independently overlap:

ΔB₀(r,g)=ΔB₀(r,g^{x})+ΔB₀(r,g^{y})+ΔB₀(r,g^{z})

The distortion model includes a modeling of a translation of the diffusion image; a modeling of a shearing of the diffusion image; a modeling of a scaling of the diffusion image; and a modeling of a nonlinear distortion of the diffusion image. The distortion model can thus be described by the following distortion function V_{g}(r,p) in the coordinate system of the diffusion image:

V_{g}(r,p)=t_{g}+m_{g}*p+s_{g}*r+v_{g}*N(r,p)

wherein r is a coordinate along the readout direction, p is a coordinate along the phase direction, t_{g} is a translation parameter, m_{g} is a scaling parameter, s_{g} is a shearing parameter, v_{g} is distortion parameter, and N(r,p) is a nonlinear distortion function. Not shown is the case of a three-dimensional modeling. The transformation is the dependent not only on the image coordinates r and p but additionally on a coordinate along the slice direction s. In addition to the translation, scaling and shearing, given a three-dimensional modeling a linear slope a*s is also taken into account as an additional transformation. A higher-order transformation can be expanded by the dependency on the slice coordinate: N(r, p, s).

Via application of the linearity principle and the superposition principle, each of the parameters t_{g}, s_{g}, m_{g}, v_{g} can be represented as a scalar product of a respective, gradient-independent parameter vector t, s, m, v with the gradient vector g:

t_{g}=t^{x}*g^{x}+t^{y}*g^{y}+t^{z}*g^{z}=t^{T}g (I)

s_{g}=s^{x}*g^{x}+s^{y}*g^{y}+s^{z}*g^{z}=s^{T}g (II)

m_{g}=m^{x}*g^{x}+m^{y}*g^{y}+m^{z}*g^{z}=m^{T}g (III)

v_{g}=v^{x}*g^{x}+v^{y}*g^{y}+v^{z}*g^{z}=v^{T}g (IV)

The distortion model can thus be described by the gradient-independent parameter vectors t, s, m, v, and the distortion function results as:

V_{g}(r,p)=t^{T}g+m^{T}g*p+s^{T}g*r+v^{T}g*N(r,p)

t=(t^{x} t^{y} t^{z})^{T} is thereby a translation parameter vector; s=(s^{x} s^{y} s^{z})^{T} is a shearing parameter vector; m=(m^{x} m^{y} m^{z})^{T} is a scaling parameter vector; and v=(v^{x} v^{y} v^{z})^{T} is a nonlinear distortion parameter vector.

For a simplified description, the parameter vectors t, s, m, v that are to be determined are combined into a model parameter vector ξ:

(V)ξ=(t^{x}t^{y}t^{z}s^{x}s^{y}s^{z}m^{x}m^{y}m^{z}v^{x}v^{y}v^{z})^{T}

The model vector of the distortion model ξ is now adapted iteratively. One iteration thereby begins with an acquisition of a diffusion image Iᵢ in the further method step 42. In FIG. 3, an iteration of the method is thereby shown. This iteration can thereby be repeated as long as diffusion images should still be acquired during the measurement of the examination subject. The multiple diffusion images (which are individually acquired by the image data acquisition unit 32 in the further method step 42) thereby have different diffusion weightings. A first diffusion image with a first diffusion weighting is thereby acquired chronologically before a second diffusion image with a second diffusion weighting, wherein the first diffusion weighting is smaller than the second diffusion weighting. The adaptation of the distortion model according to the registration of the first diffusion image with the first diffusion weighting thus also takes place chronologically before the adaptation of the distortion model according to the registration of the second diffusion image with the second diffusion weighting.

In the further method step 43, the registration of the diffusion image Iᵢ (that is acquired by means of the image data acquisition unit 32 in the further method step 42) with a diffusion gradient gᵢ=(gᵢ^{x}, gᵢ^{y}, gᵢ^{z}) with a reference image I_{ref} (acquired by means of the image data acquisition unit 32) takes place by the registration unit 34. For example, the registration tales place under the assumption of an affine distortion or a higher-order distortion and/or using information which are specific to the magnetic resonance apparatus 11. The registration of the diffusion image Iᵢ includes the use of a start value for the registration, wherein the start value is determined using the distortion model present in the current iteration.

In a further method step 50, a distortion correction parameter oᵢ=(tᵢ sᵢ mᵢ vᵢ)^{T} is determined by means of the registration unit 34 using the result of the registration of the diffusion image Iᵢ. Furthermore, in a further method step 51 a quality measure qᵢ is determined by means of a cost function used during the registration of the diffusion image Iᵢ. Alternatively or additionally, a measured value which represents a measure of the image quality of the diffusion image (for example the averaged signal-to-noise ratio) is used for the determination of the quality measure qᵢ. The distortion correction parameter oᵢ, the quality measure qᵢ and the associated diffusion gradient gᵢ are stored.

In a further method step 44, an adaptation and/or a design of the distortion model takes place by means of the adaptation unit 35 using the previously determined distortion correction parameter oᵢ=(tᵢ sᵢ vᵢ)^{T} and the quality measure qᵢ.

For this purpose, utilizing the relationships (I)-(V) a linear equation system can be set up that can be solved with a typical method. This equation system is successively supplemented with additional equations after the acquisition of additional diffusion images. A complete solution to the equation system is possible only given the presence of three linearly independent gradient directions. Therefore, the acquisition of the chronologically first diffusion images of the multiple diffusion images by means of the image data acquisition unit 32 in the further method step 42 includes a use of different diffusion directions. Furthermore, the equation system is overdetermined with an increasing number of equations, so that an approximate solution must be determined.

The following relationship exists between the model parameter vector ξ and the observed distortion correction parameters oᵢ:

oᵢ=aᵢ*ξ+ηᵢ

wherein ηᵢ is thereby a noise vector and/or an error vector and

$${a}_{i} = ( \begin{matrix}{g}_{i}^{x} & {g}_{i}^{y} & {g}_{i}^{z} & 0 & 0 & 0 & 0 & 0 & 0 & 0 & 0 & 0 \\ 0 & 0 & 0 & {g}_{i}^{x} & {g}_{i}^{y} & {g}_{i}^{z} & 0 & 0 & 0 & 0 & 0 & 0 \\ 0 & 0 & 0 & 0 & 0 & 0 & {g}_{i}^{x} & {g}_{i}^{y} & {g}_{i}^{z} & 0 & 0 & 0 \\ 0 & 0 & 0 & 0 & 0 & 0 & 0 & 0 & 0 & {g}_{i}^{x} & {g}_{i}^{y} & {g}_{i}^{z}\end{matrix} )$$

To adapt the distortion model, under consideration of all previous diffusion images in the iteration i a model parameter vector \hat{ξ} is sought for which the following expression is minimal:

$${\sum }_{j = 1}^{i} {( {a}_{j} \hat{ξ} - {o}_{j} )}^{T} ( {a}_{j} \hat{ξ} - {o}_{j} )$$

This model parameter vector \hat{ξ} can be determined by means of the known Moore-Penrose inversion in the further method step 44 by the adaptation unit 35. For this, the following simplified notation is used:

$${O}_{i} = ( \begin{matrix}{o}_{1} \\ … \\ {o}_{i}\end{matrix} ) , {A}_{i} = ( \begin{matrix}{a}_{1} \\ … \\ {a}_{i}\end{matrix} ) and {H}_{i} = ( \begin{matrix}{η}_{1} \\ … \\ {η}_{i}\end{matrix} )$$

To adapt the distortion model, under consideration of all previous diffusion images in the iteration i a model parameter vector \hat{ξ} is sought for which the following expression is minimal:

Aᵢξᵢ′=Oᵢ+Hᵢ

The solution by means of the Moore-Penrose inversion results in that

ξ′ᵢ=(Aᵢ^{T}Aᵢ)⁻¹Aᵢ^{T}Oᵢ and Hᵢ^{T}Hᵢ=(Oᵢ−Aᵢξ′ᵢ)^{T}(Oᵢ−Aᵢξ′ᵢ)

must be minimal. ξᵢ′ thus represents a solution for the least square errors of this equation:

Aᵢξ′ᵢ=Oᵢ+Hᵢ

A solution can only be calculated if the matrix Aᵢ^{T}Aᵢ is of full rank.

The adaptation of the distortion model in the further method step 44 by means of the adaptation unit 35 takes place under the weighted consideration of the distortion correction parameter oᵢ, wherein the weighting takes place using the quality measure qᵢ. The distortion correction parameter oᵢ enters with weighting into the adaptation of the distortion model. The weighting is implemented relative to distortion correction parameters which have been determined using the registration of other diffusion images, in particular diffusion images from previous iterations.

For this purpose, wᵢ is introduced as well as a weighting matrix of measurement i:

$${w}_{i} = {q}_{i} ( \begin{matrix}1 & 0 & 0 & 0 \\ 0 & 1 & 0 & 0 \\ 0 & 0 & 1 & 0 \\ 0 & 0 & 0 & 1\end{matrix} )$$

The previously described, unweighted equation system is then transitioned into a weighted equation system with the following optimization rule. The following expression must then be minimal:

$${\sum }_{i} {( {w}_{i} ( {a}_{i} \hat{ξ} - {o}_{i} ) )}^{T} ( {w}_{i} ( {a}_{i} \hat{ξ} - {o}_{i} ) )$$

The aforementioned equations and conditions for determination of ξᵢ′ retain their validity if filling takes place as follows for the weighted case Aᵢ and Oᵢ:

$${O}_{i} = ( \begin{matrix}{w}_{1} {o}_{1} \\ … \\ {w}_{i} {o}_{i}\end{matrix} ) , {A}_{i} = ( \begin{matrix}{w}_{1} {a}_{1} \\ … \\ {w}_{i} {a}_{i}\end{matrix} )$$

Alternatively, the weighting of the consideration of the distortion correction parameter oᵢ can also be implemented using at least an error covariance which is determined on the basis of the diffusion image Iᵢ by the adaptation unit 35. For this, the error covariance is modeled by the gradient norm C_{∥g∥} in order to then use the corresponding inverse of the covariance matrix in the weighting matrix, with:

wᵢ=C_{∥g}_{ᵢ}_{∥}⁻¹

In the further method step 44, the solution equation ξ′ᵢ=(Aᵢ^{T}Aᵢ)⁻¹Aᵢ^{T}Oᵢ is brought by means of the adaptation unit 35 into a form which allows an implementation that saves memory space, because only the distortion correction parameter overview image that is newly added in the current iteration is added to the existing distortion correction parameters. Therefore, no large data sets need to be held and administered in memory. For this purpose, the following is utilized:

Aᵢ^{T}Aᵢ is a 12×12 matrix, and Aᵢ^{T}Oᵢ is a 12-dimensional vector, and it applies that:

$${A}_{i + 1}^{T} {A}_{i + 1} = {( \begin{matrix}{A}_{i} \\ {a}_{i + 1}\end{matrix} )}^{T} ( \begin{matrix}{A}_{i} \\ {a}_{i + 1}\end{matrix} ) = {A}_{i}^{T} {A}_{i} + {a}_{i + 1}^{T} {a}_{i + 1}$$

$${A}_{i + 1}^{T} {O}_{i + 1} = {( \begin{matrix}{A}_{i} \\ {a}_{i + 1}\end{matrix} )}^{T} ( \begin{matrix}{O}_{i} \\ {O}_{i + 1}\end{matrix} ) = {A}_{i}^{T} {O}_{i} + {a}_{i + 1}^{T} {o}_{i + 1}$$

All observations and model matrices thus do not need to be stored over all iterations of the method. A 12×12 matrix Aᵢ^{T}Aᵢ and the 12-dimensional vector Aᵢ^{T}Oᵢ are thus sufficient. The adaptation of the distortion model in the further method step 44 by means of the adaptation unit 35 thus includes a reduction of the dimensions of the distortion model.

Furthermore, given the adaptation of the distortion model in the further method step 44 by means of the adaptation unit 35, a condition number can be calculated which describes the dependency of the estimation of the model parameter vector on the observed noise. The condition number is thereby calculated as follows:

$$cond ( {A}_{i}^{T} {A}_{i} ) = \vert \frac{{λ}_{max} ( {A}_{i}^{T} {A}_{i} )}{{λ}_{min} ( {A}_{i}^{T} {A}_{i} )} \vert$$

Wherein λₘₐₓ,λₘᵢₙ designate the largest and smallest eigenvalue. The condition number can be interpreted as an amplification factor of the input noise. For example, if the condition number is much larger than 1, an estimation of the model parameter vector should not yet be implemented with the distortion model present in the current iteration. The condition number can thus be used as a variable in the present algorithm in order to decide as of which iteration an estimation of the model parameter vector can be started.

In the further method step 52, a calculation of a value of a goodness of fit which represents a measure of the deviation of the distortion model from distortions of the diffusion image Iᵢ takes place by means of the adaptation unit 35. The goodness of fit χᵢ² is determined by means of the following formula:

$${X}_{i}^{2} = \frac{{H}_{i}^{T} {H}_{i}}{{σ}^{2}}$$

wherein σ² is the variance of the measurement system that is specific to the magnetic resonance apparatus 11.

The correction of the distortions of the diffusion image by means of the distortion model present in the current iteration is then implemented depending on the calculated value of the closeness of fit. For this purpose, in a first decision step 53 it is determined by the adaptation unit 35 whether the closeness of fit is above a first threshold. If this is the case, the distortion model present in the current iteration, with the determined model parameter vector ξᵢ′, is used to correct the distortions of the diffusion image Iᵢ in the further method step 45. If the closeness of fit is below the first threshold, the diffusion image Iᵢ of the current iteration is initially stored in a memory and is only corrected by a distortion model adapted in a later iteration, whose closeness of fit is above the first threshold. Alternatively, the diffusion images can also be corrected by the correction unit 36 of the computer 24 only after conclusion of the adaptation of the distortion model, as shown in FIG. 2.

Furthermore, an adaptation of the distortion model is finalized depending on the calculated value of the goodness of fit. For this purpose, in a second decision step 54 a check is made by means of the adaptation unit 35 as to whether the goodness of fit is above a second threshold. If this is the case, in the following iterations the distortion model is no longer adapted further. In the further method step 45, the currently present model parameter vector ξᵢ′ is then used for the correction of the distortions of all diffusion images acquired in the following iterations.

In the further method step 45, the correction of the distortions of the diffusion image Iᵢ takes place using the distortion model. The correction takes place by means of a model correction parameter k′ᵢ estimated from the distortion model. In principle, the results of all registrations of the diffusion images that have occurred up to this point are used for the correction of the diffusion image of the current iteration. The model correction parameter k′ᵢ is calculated from the currently present distortion model:

k′ᵢ=aᵢ*ξ′ᵢ

with:

$${k}_{i}^{′} = ( \begin{matrix}{t}_{i}^{′} \\ {s}_{i}^{′} \\ {m}_{i}^{′} \\ {v}_{i}^{′}\end{matrix} )$$

After a correction of the distortions (caused by eddy currents in particular) of the diffusion images has occurred, the diffusion images can be combined to create a parameter map, for example an ADC map. This parameter map can then be displayed at the display unit 25 of the magnetic resonance apparatus 11.

The method steps shown in FIG. 2 and FIG. 3 of the method according to the invention are executed by the magnetic resonance apparatus 11. For this, the computer 24 of the magnetic resonance apparatus 11 includes necessary software and/or computer programs that are stored in the memory unit of the computer. The software and/or computer programs include program means that are designed to execute the method according to the invention when the computer program and/or software is executed in the computer 24 by means of a processor unit of the magnetic resonance apparatus 11.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method to correct distortions in diffusion images of an examination subject, comprising:
providing a computer with a distortion model;
providing said computer with a reference image;
providing said computer with multiple diffusion images acquired with a magnetic resonance apparatus;
in said computer, bringing one of said multiple diffusion images into registration with said reference image;
in said computer, automatically adapting said distortion model using a result of the registration of said one of said diffusion images with said reference image;
in said computer, automatically correcting distortions in said one of said diffusion images using the adapted distortion model, thereby producing a corrected diffusion image; and
making said corrected diffusion image available in electronic form at an output of said computer.

2. A method as claimed in claim 1 comprising, in said computer, determining a quality measure based on said one of said diffusion images, and adapting said distortion model using said quality measure.

3. A method as claimed in claim 2 comprising determining, as said quality measure, a cost function used in the registration of said one of said diffusion images with said reference image.

4. A method as claimed in claim 2 comprising determining, as said quality measure, a measured value representing image quality of said one of said diffusion images.

5. A method as claimed in claim 1 comprising, in said computer, determining a distortion correction parameter using the result of said registration of said one of said diffusion images with said reference image, and adapting said distortion model using said distortion correction parameter.

6. A method as claimed in claim 5 comprising bringing an additional one of said diffusion images into registration with said reference image, determining an additional distortion correction parameter from a result of the registration of said additional one of said diffusion images with said reference image, and adapting said distortion model using a weighting of said distortion correction parameter relative to said additional distortion correction parameter.

7. A method as claimed in claim 6 comprising implementing said weighting using an error covariance determined in said computer from said one of said diffusion images and said additional one of said diffusion images.

8. A method as claimed in claim 6 comprising, in said computer, determining a quality measure from said one of said diffusion images, and weighting said distortion correction parameter relative to said additional distortion correction parameter using said quality measure.

9. A method as claimed in claim 1 comprising providing said computer with a model, as said distortion model, selected from the group consisting of modeling of a translation of said one of said diffusion images, modeling of a sheering of said one of said diffusion images, modeling of a scaling of said one of said diffusion images, and modeling of non-linear distortion of said one of said diffusion images.

10. A method as claimed in claim 1 comprising bringing said one of said diffusion images into registration with said reference image using a registration start value determined from said distortion model.

11. A method as claimed in claim 1 comprising adapting said distortion model by reducing dimensions of said distortion model.

12. A method as claimed in claim 1 comprising adapting said distortion model by calculating a value representing a closeness of fit representing a measure of a deviation of said distortion model from distortions in said one of said diffusion images.

13. A method as claimed in claim 12 comprising finalizing adaptation of said distortion model dependent on said calculated value of said closeness of fit.

14. A method as claimed in claim 12 comprising correcting distortions in said one of said diffusion images dependent on said calculated value of said closeness of fit.

15. A method as claimed in claim 1 comprising providing said computer with said multiple diffusion images individually acquired with respectively different diffusion weightings, and adapting said distortion model dependent on registration of a first of said diffusion images, acquired with a first diffusion weighting, chronologically before adapting said distortion model according to registration of a second of said diffusion images, acquired with a second diffusion weighting, wherein said first diffusion weighting is smaller than said second diffusion weighting.

16. A method as claimed in claim 1 comprising providing said computer with a chronologically first of said diffusion images acquired using different diffusion directions.

17. A method as claimed in claim 1 comprising, bringing said one of said multiple diffusion images into registration with said reference image, and automatically adapting said distortion model using said result of the registration of said one of said diffusion images with said reference image, immediately after acquiring said one of said diffusion images with said magnetic resonance apparatus and providing said one of said diffusion images to said computer.

18. A method as claimed in claim 1 comprising bringing said one of said multiple diffusion images into registration with said reference image, and adapting said distortion model using said result of the registration of said one of said diffusion images with said reference image, and automatically correcting distortions in said one of said diffusion images using the adapted distortion model, immediately after acquiring said one of said diffusion images with said magnetic resonance apparatus and providing said one of said diffusion images to said computer.

19. A magnetic resonance apparatus comprising:
a magnetic resonance data acquisition unit;
a computer provided with a distortion model and provided with a reference image;
said computer being configured to operate said magnetic resonance data acquisition unit to acquire with multiple diffusion images;
said computer being configured to bring one of said multiple diffusion images into registration with said reference image;
said computer being configured to automatically adapt said distortion model using a result of the registration of said one of said diffusion images with said reference image;
said computer being configured to automatically correct distortions in said one of said diffusion images using the adapted distortion model, thereby producing a corrected diffusion image; and
said computer being configured to make said corrected diffusion image available in electronic form at an output of said computer.

20. A non-transitory, computer-readable data storage medium encoded with programming instructions, said storage medium being loaded into a computer, and said programming instructions causing said computer to:
receive or generate a distortion model;
receive or generate a reference image;
receive multiple diffusion images acquired with a magnetic resonance apparatus;
bring one of said multiple diffusion images into registration with said reference image;
automatically adapt said distortion model using a result of the registration of said one of said diffusion images with said reference image;
automatically correct distortions in said one of said diffusion images using the adapted distortion model, thereby producing a corrected diffusion image; and
make said corrected diffusion image available in electronic form at an output of said computer.
